(19) United States
(12) Patent Application Publication
(10) Pub. No.: US 2024/0319019 A1
(43) Pub. Date: Sep. 26, 2024

(54) TEMPERATURE SENSOR

(71) Applicant: Commissariat à l'Energie Atomique et aux Energies Alternatives, Paris (FR)

(72) Inventor: Franck BADETS, Grenoble Cedex 09 (FR)

(21) Appl. No.: 18/604,011

(22) Filed: Mar. 13, 2024

(30) Foreign Application Priority Data
Mar. 21, 2023 (FR) 2302623

(51) Int. Cl. G01K 7/16; G01K 15/00

(52) U.S. Cl. CPC G01K 7/16; G01K 15/005

(57) ABSTRACT

The present description concerns a temperature sensor (2) comprising a first oscillator (LO1′) and a second oscillator (LO2′), a counter (COUNTER) of a number (P) of periods of the second oscillator (LO2′) over a duration determined by the first oscillator (LO1′). One of the first and second oscillators (LO1′, LO2′) comprises a resistive component (R) and has its frequency linearly depending on temperature according to a coefficient which is a multiple of the inverse of a resistance value of the resistive component (R). The resistive component (R) is a switched capacitive element (C) controlled at a frequency determined by the other of the first and second oscillators.

### FIELD

The present disclosure generally concerns electronic circuits, and more particularly temperature sensors.

### BACKGROUND

Many integrated circuits, for example on silicon, comprise a temperature sensor. This temperature sensor, or temperature measurement circuit, enables to measure the temperature of the integrated circuit, for example to allow an adjustment of the parameters of the integrated circuit, such as its supply voltage, according to the measured temperature.

A known type of temperature sensor uses a differential measurement of a time quantity, either between a temperature-constant time quantity and a time quantity varying with temperature, or between two time quantities varying with temperature but with very different temperature coefficients. An example of a time quantity is the frequency of an oscillator.

However, known temperature sensors based on differential frequency measurement have disadvantages.

### SUMMARY

There exists a need to overcome all or part of the disadvantages of known integrated temperature sensors based on a differential frequency measurement.

An embodiment overcomes all or part of the disadvantages of known integrated temperature sensors based on a differential frequency measurement.

An embodiment provides a temperature sensor comprising:
a first oscillator and a second oscillator; and a counter configured to count a number of periods of the second oscillator over a duration determined by a period of the first oscillator,
wherein:
one of the first and second oscillators is configured so that its frequency linearly depends on temperature or on the inverse of temperature according to a multiple coefficient of the inverse of a resistance value of a resistive component of said one of the first and second oscillators; said resistive component is implemented by a switched capacitive element; and a control frequency of the switched capacitive element is determined by the frequency of the other one of the first and second oscillators.

According to an embodiment, said one of the first and second oscillators comprises: an oscillating circuit; and a current source configured to deliver a bias current to the oscillating circuit, the current source being of a type proportional to the absolute temperature or of a type complementary to the absolute temperature.

According to an embodiment:
the current source comprises the resistive component;
the resistive component is configured to convert a voltage into a first current; and
the current source is configured so that the bias current is a copy of the first current to within a multiplication factor.

According to an embodiment, the oscillating circuit is a ring oscillator.

According to an embodiment, the oscillating circuit is a relaxation oscillator comprising an RS flip-flop.

According to an embodiment, the oscillating circuit comprises the resistive component.

According to an embodiment:
said oscillating circuit comprises at least one first inverter having its threshold voltage determining the frequency of said one of the first and second oscillators; and said one of the first and second oscillators further comprises:
a second inverter identical to the first oscillator and having its output connected to its input, an error amplifier configured to deliver a signal indicating a deviation between an output voltage of the second inverter and a reference threshold voltage, and
a circuit configured to control a threshold voltage of the first and second inverters based on the signal delivered by the error amplifier so that the threshold voltage of the first and second inverters is equal to the reference voltage.

According to an embodiment, the sensor comprises a calibration circuit configured to:
receive from the counter the number P of periods of the second oscillator counted over the duration determined by the period of the first oscillator;
determine, when the calibration circuit receives a calibration request, and based on a known calibration temperature and on number P, a constant coefficient J such that:
   a) P is equal to J times the calibration temperature if said one of the first and second oscillators is the first oscillator and has its frequency linearly depending on the inverse of temperature or if said one of the first and second oscillators is the second oscillator and has its frequency linearly depending on temperature; or
   b) P is equal to J times the inverse of temperature if said one of the first and second oscillators is the second oscillator and has its frequency linearly depending on the inverse of temperature or if said one of the first and second oscillators is the first oscillator and has its frequency linearly depending on temperature.

According to an embodiment, the sensor comprises a calculation circuit configured to determine a temperature value based on said counted number.

According to an embodiment, the sensor is configured so that the duration determined by the frequency of the first oscillator is at least 100 times greater than a period of the second oscillator.

According to an embodiment, the sensor is configured so that the control frequency of the switched capacitive element is at least 10 times greater than the frequency of said one of the first and second oscillators.

According to an embodiment, each of the first and second oscillators comprises no quartz.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 shows, in the form of blocks, an example of a temperature sensor;

FIG. 2 shows, in the form of blocks, an embodiment of a temperature sensor;

FIG. 3 shows, in the form of blocks, an embodiment of an oscillator of the sensor of FIG. 2;

FIG. 4 shows an example of embodiment of a current source of the oscillator of FIG. 3;

FIG. 5 shows an example of embodiment of an oscillating circuit of the oscillator of FIG. 3; and

FIG. 6 shows an example of a circuit of the oscillator of FIG. 3.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, the various known integrated circuits having a temperature sensor integrated therein have not been detailed, the described embodiments and variants being compatible with these known integrated circuits.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

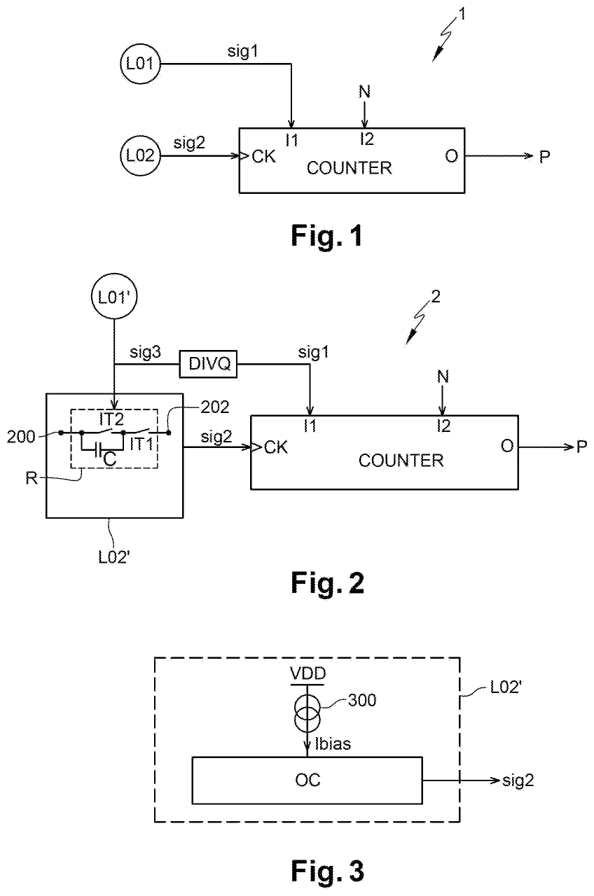

FIG. 1 shows, in the form of blocks, an example of a temperature sensor 1, and more particularly of a temperature sensor 1 based on a differential frequency measurement.

Sensor 1 comprises a first oscillator LO1 and a second oscillator LO2, as well as a counter COUNTER.

Counter COUNTER is configured to count, over a duration D determined by the period of first oscillator LO1, that is, by the period of an output signal of oscillator LO1, a number P of periods of the second oscillator. Duration D corresponds to a multiple, preferably an integer multiple, of the period of oscillator LO1.

For example, counter COUNTER comprises an input I1 configured to receive a signal sig1 at a period determined by the period of oscillator LO1, that is, a signal sig1 having a period which is a multiple, preferably an integer multiple, of the period of the output signal of oscillator LO1. For example, signal sig1 is the output signal of oscillator LO1.

For example, counter COUNTER further comprises an input I2 configured to receive a number N, preferably an integer. Number N determines, with the period of signal sig1, counting duration D. Indeed, counter COUNTER is configured so that duration D is equal to N times T1, with T1 the period of signal sig1.

For example, counter COUNTER further comprises an input CK configured to receive the output signal sig2 of oscillator LO2.

For example, counter COUNTER comprises an output O configured to deliver number P.

At the end of a counting duration D, number P is equal to N.F2/F1 with F1 the frequency of signal sig1, and F2 the frequency of signal sig2.

At least one of oscillators LO1 and LO2 has its frequency linearly depending on temperature T or on the inverse of temperature (that is, 1/T).

For example, if the frequency F1 of signal sig1, and thus the frequency of oscillator LO1, is independent from temperature, and the frequency F2 of signal sig2 linearly depends on temperature T according to relation F2=A.T, with A a constant coefficient, then P=N.A.T/F1. Since frequency F1 is temperature-constant, number N is known, and coefficient A is constant, P=B.T with B=N.A/F1. Determining B, for example during a calibration step, the measured temperature T is directly equal to ratio P/B.

For example, when the frequency F1 of signal sig1, and thus the frequency of oscillator LO1, is independent from temperature, and the frequency F2 of sig2 signal linearly depends on the inverse of temperature T according to relation F2=A/T, with A a constant coefficient, then P=N.A/(F1.T). Since frequency F1 is temperature-constant, number N is known and coefficient A is constant, P=B/T with B=N.A/F1. Determining B, for example during a calibration step, the measured temperature T is directly equal to ratio B/P.

For example, when the frequency F2 of signal sig2 is independent from temperature and the frequency F1 of signal sig1, and thus the frequency of oscillator LO1, linearly depends on temperature T according to relation F1=E.T, with E a constant coefficient, then P=N.F2/(E.T). Since frequency F2 is temperature-constant, number N is known, and coefficient E is constant, P=B/T with B=N.F2/E. Determining B, for example during a calibration step, the measured temperature T is directly equal to ratio B/P.

For example, when the frequency F2 of signal sig2 is independent from temperature and the frequency F1 of signal sig1, and thus the frequency of oscillator LO1, linearly depends on the inverse of temperature T according to relation F1=E/T, with E a constant coefficient, then P=N.F2.T/E. Since frequency F2 is temperature-constant, number N is known, and coefficient E is constant, P=B.T with B=N.F2/E. Determining B, for example during a calibration step, the measured temperature T is directly equal to ratio P/B.

In the above examples, one of the oscillators must have a frequency independent from temperature. The implementation of such an oscillator may be performed by means of a quartz, but this is not desirable to limit the complexity, the bulk, and the cost of sensor 1. An oscillator supplying a frequency independent from temperature may also be implemented otherwise than with a quartz, but at the cost of an even greater complexity of sensor 1.

On the other hand, even when using an oscillator which intrinsically has its frequency which does not depend on temperature, in practice this oscillator has to be biased with a biasing circuit, which generally comprises one or a plurality of resistors. These resistors have resistance values which depend on temperature, whereby, in practice, the frequency of this oscillator will not be totally independent from temperature. It is thus necessary to take at least two calibration points to determine the relation between temperature T (or the inverse of the temperature, 1/T) and the counted number P.

In other examples, frequencies F1 and F2 may both depend on temperature. At least two calibration points are then necessary to be able to determine the measured temperature based on number P, which is not desirable.

FIG. 2 shows, in the form of blocks, an embodiment of a temperature sensor 2 based on a differential measurement of the frequency of an oscillator.

Sensor 2 comprises, like sensor 1, an oscillator LO1′, an oscillator LO2′, and counter COUNTER. Counter COUNTER is, for example, identical to that described in relation with FIG. 1. In particular, counter COUNTER is configured to count the number P of periods of oscillator LO2′ over a duration D determined by the period of oscillator LO1′.

Oscillator LO1′ delivers a periodic sig3 signal at frequency F3. Frequency F3 determines counting duration D. More particularly, duration D is equal to N*T1, with T1 the period of a signal sig1 having a frequency F1 determined by the frequency F3 of signal sig3, and thus the frequency F3 of oscillator LO1′. In other words, the frequency F1 of signal sig1 is equal to 1/Q times the frequency F3 of signal sig3, with Q a constant number greater than or equal to 1, Q preferably being an integer. Thus, duration D is equal to N.Q/F3 and is thus effectively determined by the period T3 of signal sig3. Signal sig3 and number N are supplied to counter COUNTER.

For example, when coefficient Q is greater than 1, sensor 2 comprises a circuit DIVQ configured to receive signal sig3 and to deliver signal sig1 with a frequency F1 equal to 1/Q times the frequency F3 of signal sig3. In other words, circuit DIVQ is a divider of the frequency by Q configured to deliver signal sig1 based on signal sig3.

As an alternative example, when coefficient Q is equal to 1, circuit DIVQ may be omitted, signal sig1 then directly being signal sig3.

As an example, numbers N and Q are constant numbers set once for the entire duration of operation of sensor 2. As an alternative example, at least one of numbers N and Q is a parameter which is set by the user, so that the user can modify the value of this number, for example during the lifetime of sensor 2 and/or according to the application embedding sensor 2.

Oscillator LO2′ delivers a periodic sig2 signal at frequency F2. Signal sig2 is supplied to counter COUNTER.

As an example, as in FIG. 1, signal sig1 is supplied to input I1 of counter COUNTER, number N is supplied to input I2 of counter COUNTER, signal sig2 is supplied to input CK of counter COUNTER, and the output O of the counter delivers number P.

Similarly to what has been indicated in relation with FIG. 1, at the end of each counting duration D, number P is equal to N.F2/F1, and thus to N′.F2/F3 with N′ equal to N.Q.

One of oscillators LO1′ and LO2′ is configured so that its frequency linearly depends on temperature T, or on the inverse of temperature (1/T). Further, this oscillator LO1′ or LO2′ is configured so that its frequency is partly determined by the inverse of a resistance value Rv of a resistive component R of this oscillator. In other words, this oscillator is configured so that the coefficient linearly linking temperature T (or the inverse of temperature T) to its frequency is a multiple of 1/Rv, with Rv the resistance value of resistive component R.

In the example of embodiment of FIG. 2, oscillator LO2′ is configured so that its frequency F2 linearly depends on temperature T, according to a constant coefficient which is a multiple of 1/Rv, component R then forming part of oscillator LO1′.

Further, resistive component R is implemented by a switched capacitive element. In other words, component R is a switched capacitive element. Switched capacitive element R comprises a capacitive element C, a switch IT1 series-connected with component C between terminals 200 and 202 of resistive component R, and a switch IT2 connected in parallel with element C. Switches IT1 and IT2 are controlled in phase opposition. The control frequency Fc of switched capacitive element R is determined by the frequency of the oscillator LO1′ or LO2′ which does not comprise element R, that is, by the frequency F3 of oscillator LO1′ in the example of FIG. 2. In other words, frequency Fc is equal to H times the frequency of the oscillator LO1′ or LO2′ which does not comprise component R, that is, H times frequency F3 in the example of FIG. 1, H being a constant positive number. Preferably, H is selected so that frequency Fc is at least ten times greater than the frequency of the oscillator LO1′ or LO2′ having component R implemented therein, that is, so that H.F3>10.F2 in the example of FIG. 2.

Thus, in the example of FIG. 2, where F2 is equal to G.T/Rv with G a constant coefficient, since the resistance value Rv of resistive component R is equal to 1/(Cv.Fc), with Cv the capacitance value of capacitive element C, then F2=G.T.Cv.Fc=G.T.Cv.F3.H.

Replacing F2 with its above expression in equation P=N′.F2/F3, this results in that P is equal to N′.G.T.Cv.H. Since N′, G, Cv, and H are constants, P is equal to J.T, with J a constant coefficient equal to N′.G.Cv.H.

Advantageously, coefficient J does not depend on the frequency F3 of oscillator LO1′. The frequency F3 of oscillator LO1′ can then depend on temperature, without for this to modify the value of coefficient J, and thus without for this to distort the measurement of T. Indeed, to determine T based on P, it is then sufficient to know coefficient J.

According to an embodiment, the oscillator LO1′ or LO2′ which does not comprise component R does not comprise a quartz either, and, more generally, none of oscillators LO1′ and LO2′ comprises a quartz. This enables to decrease the complexity, the bulk, and the cost of sensor 2 as compared with a sensor 1 in which either oscillator LO1 or oscillator LO2 comprises a quartz.

According to an embodiment, oscillators LO1′ and LO2′ have the same structure or topology, which enables to decrease the dependence of sensor 2 on the power supply voltage and/or on the common-mode noise. For example, the two oscillators LO1′ and LO2′ each comprise a ring oscillator, or each comprise a relaxation oscillator, for example a relaxation oscillator comprising an RS Flip-Flop.

According to an embodiment, the value of coefficient J is determined during a calibration phase. For example, when a calibration is required, a number P is counted over a corresponding duration D, knowing the calibration temperature T1 at which sensor 2 is placed. The value of the coefficient J is then equal to P/T1 in the example of FIG. 2. Advantageously, only one calibration point is required.

According to an embodiment, the calibration phase is implemented by a circuit for calibrating sensor 2 (not shown in FIG. 2). This calibration circuit is configured to receive the number P counted by counter COUNTER over a duration D, and to determine, when the calibration circuit receives a calibration request corresponding to this counting duration D, the coefficient J linking number P to the known calibration temperature T1. This assumes that the calibration request received by the calibration circuit is issued while sensor 2 is at calibration temperature T1. As an example, the calibration request is supplied to sensor 2 and to its calibration circuit by an operator having previously placed sensor 2 at calibration temperature T1. The value of calibration temperature T1 may be known in advance and stored in a memory of the calibration circuit, or be supplied to sensor 2 and to its calibration circuit together with the calibration request.

According to an embodiment, sensor 2 comprises a calculation circuit (not shown in FIG. 2). The calculation circuit is configured to determine the value of temperature T based on number P. More exactly, the calculation circuit is configured to determine the temperature value based on number P and on the constant coefficient J linking P to temperature T.

Preferably, to obtain a sufficient measurement accuracy, duration D is selected to be at least 100 times greater than the duration of a period of oscillator LO2′.

Preferably, the control frequency Fc of switched capacitive element R is at least 10 times greater than the frequency of the oscillator comprising this switched capacitive element R, that is, the frequency F2 of oscillator LO2′ in the example of FIG. 2. Thus, in the example shown in FIG. 2, preferably, Fc>10.F2.

FIG. 3 shows a block diagram of an example of an oscillator of the sensor shown in FIG. 2. In particular, FIG. 3 shows, in the form of blocks, an example of embodiment of the oscillator of sensor 2 which comprises switched capacitive element R, that is, oscillator LO2′, taking the example of FIG. 2. However, oscillator LO1′ may be implemented in the same way in the case where switched capacitive element R forms part of oscillator LO1′ rather than of oscillator LO2′.

Oscillator LO2′ comprises an oscillating circuit OC, for example, a relaxation oscillator which may comprise an RS flip-flop, or a ring oscillator. Circuit OC delivers the output signal of the oscillator, that is, the output signal sig2 of oscillator LO2′ in this example.

Oscillator LO2′ further comprises a current source 300 configured to deliver a bias (or supply) current Ibias to oscillating circuit OC.

Current source 300 is either of CTAT (Complementary To Absolute Temperature) or PTAT (Proportional To Absolute Temperature) type. Thus, current Ibias varies linearly with temperature.

As an example, current source 300 has one terminal connected to a power supply potential VDD and another terminal connected to a power supply terminal of circuit OC.

According to an embodiment, although this is not shown in FIG. 3, switched capacitive element R (FIG. 2) forms part of oscillating circuit OC.

As a variant, although this is not illustrated in FIG. 3, switched capacitive element R (FIG. 2) forms part of current source 300. Preferably, in such a variant, resistive element R is configured to convert a voltage between terminals 200, 202 (FIG. 2) of resistive element R into a first current, and current source 300 is configured so that its current Ibias varies proportionally, for example linearly, with this first current. More precisely, when source 300 is of PTAT, respectively CTAT, type, component R is configured to convert a PTAT, respectively CTAT, voltage into a first PTAT, respectively CTAT, current, and source 300 is configured so that current Ibias varies proportionally, for example linearly, with the first current.

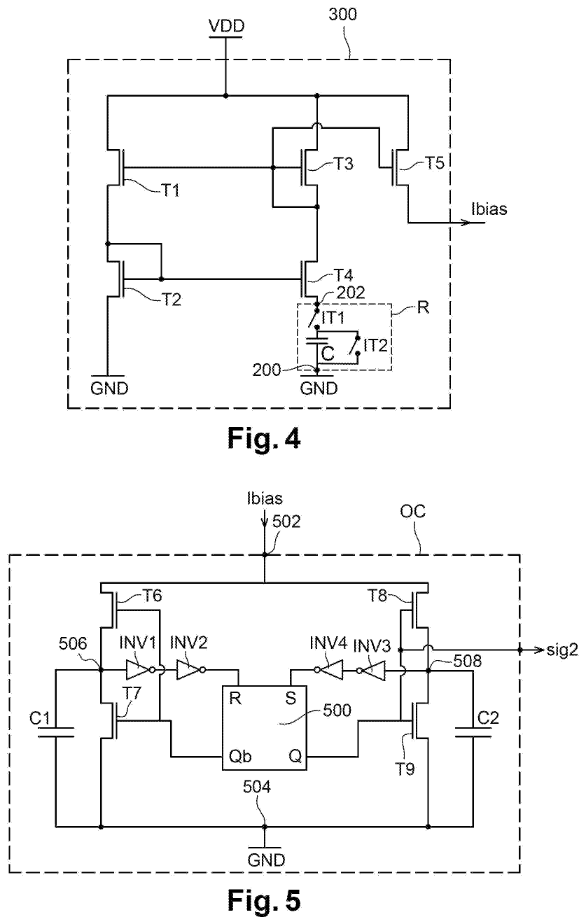

FIG. 4 shows an example of embodiment of the current source 300 of the oscillator shown in FIG. 3. In this example of embodiment, current source 300 is of PTAT type.

Current source 300 comprises two MOS (Metal Oxide Silicon) transistors T1 and T2 in series between a power supply potential VDD and a reference potential GND, transistor T1 being connected to potential VDD and transistor T2 being connected to potential GND. In this example where potential VDD is positive with respect to potential GND, transistor T1 is a P-channel MOS transistor, and transistor T2 has an N channel. For example, the source of transistor T1 is connected to potential VDD, the drain of transistor T1 is connected to the drain of transistor T2, and the source of transistor T2 is connected to potential GND. Further, transistor T2 has its drain connected to its gate.

Current source 300 further comprises a resistive element and two MOS transistors T3 and T4 in series between power supply potential VDD and reference potential GND, transistor T3 being connected to potential VDD and transistor T4 being coupled to potential GND by the resistive element. The series association of transistors T1 and T2 is connected in parallel with the series association of transistors T3 and T4 and of the resistive element. In this example where potential VDD is positive with respect to potential GND, transistor T3 is a P-channel MOS transistor, and transistor T4 has an N channel. For example, the source of transistor T3 is connected to potential VDD, the drain of transistor T3 is connected to the drain of transistor T4, and the source of transistor T4 is coupled to potential GND by the resistive element. Further, transistor T3 has its drain connected to its gate.

Further, transistors T1 and T3 have their gates connected to each other, and transistors T2 and T4 have their gates connected to each other.

The resistive element coupling transistor T4 to potential GND is configured to convert a voltage thereacross into a first current, and current source 300 is configured so that its current Ibias copies this first current, that is, so that current Ibias is equal to the first current to within a multiplication factor, this multiplication factor being constant.

In this example of embodiment, resistive component R forms part of current source 300, and corresponds to the resistive element coupling transistor T4 to potential GND.

In another example, not shown, where resistive component R forms part of oscillating circuit OC, the resistive element coupling transistor T4 to GND potential is implemented by a resistor.

Current source 300 further comprises a MOS transistor T5, with a channel of the same type as that of transistor T3. Transistor T5 has its gate connected to the gate of transistor T3, its source connected to potential VDD, and its drain configured to deliver current Ibias.

In the example of FIG. 4, current Ibias is equal to ((k.T)/(Rv.q)).ln(n), with k Boltzmann's constant, T the temperature in Kelvin, q the charge of an electron, n the ratio of the widths of transistors T2 and T4, and Rv the resistance value of component R in ohms.

Thus, current Ibias varies linearly with temperature.

Although an example of a PTAT-type current source has been described above, those skilled in the art will be capable of providing other examples of PTAT-type current sources, and, more generally, other PTAT or CTAT-type current sources 300. Preferably, in these other examples of implementation of current source 300, when current source 300 comprises resistive component R, this component R is configured to convert a voltage between its terminals 200, 202 into a first current and source 300 is configured so that current Ibias is a copy of the first current, that is, is equal to the first current to within a multiplication factor, this multiplication factor being constant.

FIG. 5 shows an example of embodiment of the circuit OC of the oscillator of FIG. 3.

In this example, circuit OC is a relaxation oscillator, and, more exactly, a relaxation oscillator comprising an RS flip-flop (designated with reference 500 in FIG. 5).

In this example, component R (FIG. 2) does not form part of circuit OC, and forms part of current source 300, the latter being for example implemented as shown in FIG. 4.

Circuit OC comprises a power supply terminal 502 configured to receive current Ibias.

Circuit OC comprises two MOS transistors T6 and T7 in series between node 502 and a node 504 configured to receive reference potential GND, and two MOS transistors T8 and

T9 series-connected between nodes 502 and 504, transistors T6 and T8 being connected to node 502 and transistors T7 and T9 being connected to node 504.

In this example where the potential VDD having the source 300 delivering current Ibias (FIG. 2) connected thereto is positive with respect to potential GND, transistors T6 and T8 have a P channel and transistors T7 and T9 have an N channel.

For example, transistors T6 and T8 have their sources connected to node 502 and their drains connected to the drains of transistors T7 and T9 respectively, the latter having their sources connected to node 504.

The gates of transistors T6 and T7 are connected to an output Qb of flip-flop 500, and the gates of transistors T8 and T9 are connected to an output Q of flip-flop 500.

A capacitive element C1 couples node 504 to a node 506 of connection of transistor T6 to transistor T7, and a capacitive element C2 couples node 504 to a node 508 of connection of transistor T8 to transistor T9. Preferably, and although this is not indispensable, capacitive elements C1 and C2 are identical, that is, they have a same capacitance value.

Circuit OC further comprises an even number of inverters in series coupling node 506 to an input R of flip-flop 500 and the same even number of inverters in series coupling node 506 to an input S of the RS flip-flop.

In the example of FIG. 5, circuit OC comprises two inverters INV1 and INV2 in series coupling node 506 to input R, and two inverters INV3 and INV4 coupling node 508 to input S. Inverter INV1 has its input connected to node 506, and inverter INV3 has its input connected to node 508. As an example, at least inverters INV1 and INV3 are identical, and preferably inverters INV1 to INV4 are all identical.

The output signal sig2 of oscillating circuit OC, and thus of oscillator LO2′ in this example, has a frequency F2 equal to Ibias/(2.C1v.Vth), where C1v is the capacitance value of each of capacitive elements C1 and C2, and Vth the switching threshold of inverters INV1 and INV3.

Thus, in this example, due to the fact that current Ibias linearly depends on temperature T and is partly determined by value 1/Rv, frequency F2 will also linearly depend on temperature T according to a constant multiple coefficient 1/Rv. In other words, F2 is equal to G.T/Rv with G a constant coefficient. Since value Rv is equal to 1/(Cv.Fc), then F2=G.T.Cv.Fc, whereby F2=G.T.Cv.F3.H due to the fact that Fc=H.F3. By injecting the above expression of F2 into equation P=N′.F2/F3, P results being equal to N′.G.T.Cv.H, and thus J.T, with J a constant coefficient equal to N′.G.Cv.H.

More particularly, in the case where source 300 is implemented as illustrated in relation with FIG. 4 and where the oscillator is implemented as described in relation with FIG. 5, current Ibias is equal to ((k.T)/(Rv.q)).ln(n), and thus to ((k.T.Cv.Fc)/q).ln(n)=((k.T.Cv.F3.H)/q).ln(n), and frequency F2 is equal to Ibias/(2.C1v.Vth). As a result, F2=(k.T.Cv.F3.H.ln(n))/(q.2.C1v.Vth). By replacing F2 with its above expression in equation P=N′.F2/F3, one has:

P=(N′.k.T.Cv.F3.H.ln(n))/(q.2.C1v.Vth.F3), and thus

P=(N′.k.T.Cv.H.ln(n))/(q.2.C1v.Vth), or

P=J.T with J=(N′.k.Cv.H.ln(n))/(q.2.C1v.Vth), coefficient J being constant and independent from temperature, at least at the first order.

An advantage of the above specific example is that coefficient J does not depend on any resistance value which might vary with temperature.

Another advantage of this specific example is that the capacitance value ratio Cv/C1v is independent from temperature at the first order, since it is a ratio of values which, although they vary with temperature T, have identical temperature variation coefficients.

Although threshold Vth may depend on temperature T, this temperature dependence of threshold Vth is negligible as compared with the temperature dependence of current Ibias, and threshold Vth can be considered as constant.

To determine coefficient J, a calibration phase such as previously described in relation with FIG. 2 may be implemented, in particular, in the above specific example, to determine the value of threshold Vth, which may depend on the manufacturing process.

The specific example described hereabove illustrates an embodiment where oscillator LO2′ has its frequency F2 linearly depending on T according to a constant coefficient which is a multiple of 1/Rv, and where switched capacitive element R of value Rv is implemented in current source 300.

As an alternative example, oscillator LO2′ may be implemented as described in relation to FIG. 3 and its circuit OC is a ring oscillator.

In other embodiments, switched capacitive element R is implemented in the circuit OC of oscillator LO2′, and the switched capacitive element R of current source 300 is replaced with a resistive component.

As indicated in relation with the specific example of FIG. 5, the threshold Vth of an inverter depends on temperature T, but this dependence may be neglected.

More generally, in an oscillator of the type described in relation with FIG. 3, when the frequency of the oscillating circuit OC of this oscillator is at least partly determined by the threshold voltage Vth of one or a plurality of inverters of oscillating circuit OC, the temperature dependence of threshold Vth is considered as negligible.

However, to improve the measurement accuracy of a sensor 2 where the oscillator comprising switched capacitive element R is of the type described in relation with FIG. 3 and has its frequency at least partly determined by the threshold voltage Vth of one or a plurality of inverters of the oscillating circuit OC of this oscillator, an embodiment provides controlling the threshold voltage Vth of these inverters to make it made constant and independent from temperature.

In such an embodiment, this oscillator has a circuit configured to keep voltage Vth constant and independent from temperature, for example by modifying the supply power delivered to these inverters and/or by modulating the back gate voltage of the transistors implementing these inverters in SOI (Silicon On Insulator) technology.

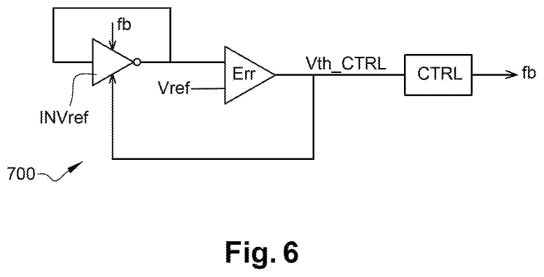

FIG. 6 shows an example of such a circuit for controlling the voltage Vth of inverters of the oscillating circuit OC of an oscillator, for example the inverters INV1 and INV3 of the oscillating circuit OC of FIG. 5.

The circuit, designated with reference 700 in FIG. 6, comprises an inverter INVref identical to the inverter or to the inverters having their threshold Vth controlled by circuit 700.

Inverter INVref has its output connected to its input, whereby its output is at the threshold voltage Vth of inverter INVref.

Circuit 700 further comprises an error amplifier ERR configured to deliver a signal Vth_CTRL representative of the error, or deviation, between the output voltage of inverter INVref, equal to Vth, and a reference or setpoint voltage Vref.

Circuit 700 further comprises a circuit CTRL configured to deliver a signal fb based on signal Vth_CTRL. Circuit ERR is configured to control the threshold voltage of inverter INVref and of the inverters, for example INV1 and INV3, of circuit OC, so that the output voltage of inverter INVref, and thus the threshold voltage Vth of this inverter INVref and of the inverters of circuit OC having their voltage Vth controlled by circuit 700, is equal to voltage Vref.

Thus, circuit 700 enables to control the threshold voltage of the inverters that it controls with reference voltage Vref.

For example, when the inverters are implemented by MOS transistors on SOI, signal fb is a signal for controlling the back gate of these transistors.

Examples of embodiments have been described above, where oscillator LO2′ has its frequency F2 which linearly depends on temperature and comprises the switched capacitive element R controlled based on the frequency F3 of oscillator LO1′.

Those skilled in the art are capable of providing, based on the description made hereabove, embodiments where oscillator LO2′ has its frequency F2 which linearly depends on the inverse of temperature, that is, on 1/T, and comprises switched capacitive element R controlled based on the frequency F3 of oscillator LO1′. In this case, frequency F2 is equal to G/(Rv.T) with G a constant coefficient and the value Rv of resistive component R is equal to 1/(Cv.Fc), that is, to 1/(Cv.H.F3) with H a constant coefficient, whereby F2=(G.Cv.F3.H)/T. By replacing F2 with its above expression in equation P=N′.F2/F3, P results being equal to (N′.G.Cv.H)/T, and thus to J/T, with J a constant coefficient equal to N′.G.Cv.H. Advantageously, coefficient J then does not depend on the frequency F3 of oscillator LO2′. To determine T based on P, it is then sufficient to know coefficient J, for example by determining it during a calibration phase as described in relation with FIG. 2, this calibration phase being implemented, for example, by the calibration circuit described in relation with FIG. 2.

In these embodiments, when the frequency of oscillator LO2′, and thus coefficient J, depends on the threshold voltage Vth of one or a plurality of inverters of oscillator LO2′, those skilled in the art will be capable of implementing a control of the threshold voltage Vth of this or these inverters, for example by means of the circuit 700 described in relation with FIG. 6, so that this voltage Vth is constant and independent from temperature.

Examples of embodiments have been described above, where LO2′ oscillator has its frequency F2 which linearly depends on temperature or on the inverse of temperature, and comprises switched capacitive element R controlled based on the frequency F3 of oscillator LO1′.

Those skilled in the art are capable of providing, based on the description made hereabove, embodiments where oscillator LO1′ has its frequency F3 which linearly depends on temperature or on the inverse of temperature, and comprises switched capacitive element R, this switched capacitive element then being controlled based on the frequency F2 of oscillator LO2′. In this case, for example, oscillator LO1′ is implemented as described in relation with FIG. 3.

For example, those skilled in the art are capable of providing, based on the description made hereabove, embodiments where oscillator LO1′ has its frequency F3 which linearly depends on temperature T and comprises switched capacitive element R controlled based on the frequency F2 of oscillator LO2′. In this case, frequency F3 is equal to G.T/Rv, with G a constant coefficient, and the value Rv of switched capacitive element R is equal to 1/Cv.Fc, with Fc=H.F2 and H a constant coefficient. As a result, F3=G.Cv.H.F2.T. By replacing F3 with its above expression in equation P=N′.F2/F3, P results being equal to (N′.F2)/(G.Cv.H.F2.T), and thus to J/T with J a constant coefficient equal to N′/(G.Cv.H). Advantageously, coefficient J does not depend on the frequency F2 of oscillator LO2′, which may vary with temperature. To determine T based on P, it is then sufficient to know coefficient J, for example by determining it during a calibration phase as described in relation with FIG. 2, this calibration phase being for example implemented by the calibration circuit described in relation with FIG. 2.

As an alternative example, those skilled in the art are capable of providing, based on the description made hereabove, embodiments where oscillator LO2′ has its frequency F3 which linearly depends on the inverse of temperature, 1/T, and comprises switched capacitive element R controlled based on the frequency F2 of oscillator LO2′. In this case, frequency F3 is equal to G/(Rv.T), with G a constant coefficient, and the value Rv of switched capacitive element R is equal to 1/Cv.Fc, with Fc=H.F2 and H a constant coefficient. As a result, F3=(G.Cv.H.F2)/T. By replacing F3 with its above expression in equation P=N′.F2/F3, P results being equal to (N′.F2.T)/(G.Cv.H.F2), and thus to J.T, with J a constant coefficient equal to N′/(G.Cv.H). Advantageously, coefficient J does not depend on the frequency F2 of oscillator LO2′, which may vary with temperature. To determine T based on P, it is then sufficient to know coefficient J, for example by determining it during a calibration phase as described in relation with FIG. 2, this calibration phase being implemented, for example, by the calibration circuit described in relation with FIG. 2.

In these embodiments, when the frequency of oscillator LO2′, and thus coefficient J, depends on the threshold voltage Vth of one or a plurality of inverters of oscillator LO2′, those skilled in the art will be capable of implementing a control of the threshold voltage Vth of this or these inverters, for example by means of the circuit 700 described in relation with FIG. 6, so that this voltage Vth is constant and independent from temperature.

Thus, in all the described examples of embodiments and of variants, the oscillator LO1′ or LO2′ which does not comprise switched capacitive element R and which has its frequency which linearly depends on T/Rv or on 1/(T.Rv) can have its frequency which depends on temperature without for this to alter the temperature measurement, due to the fact that its frequency determines the control frequency Fc of switched capacitive element R, which enables to eliminate the influence of this frequency oscillator in the linear relation between P and temperature T or the inverse of temperature, 1/T.

Various embodiments and variants have been described. Those skilled in the art will understand that certain features of these various embodiments and variants may be combined, and other variants will occur to those skilled in the art. In particular, the implementation of the oscillator LO1′ or LO2′ comprising switched capacitive element R is not limited to the structure described in relation with FIG. 3, let alone to the examples of current sources 300 and of oscillating circuits OC described in relation with FIGS. 3 to 5. Further, when the oscillator LO1′ or LO2′ comprising switched capacitive element R has a structure of the type of that of FIG. 3, those skilled in the art will be capable of providing a source 300 of CTAT type rather than PTAT as described in relation with FIG. 4. In particular, those skilled in the art will be capable, in embodiments, to implement source 300 so that it comprises switched capacitive element R to convert a voltage into a current determining current Ibias.

Finally, the practical implementation of the described embodiments and variants is within the abilities of those skilled in the art based on the functional indications given hereabove.

1. Temperature sensor comprising:
a first oscillator and a second oscillator; and
a counter configured to count a number of periods of the second oscillator over a duration determined by a period of the first oscillator,
wherein:
one of the first and second oscillators is configured so that its frequency linearly depends on temperature or on the inverse of temperature according to a multiple coefficient of the inverse of a resistance value of a resistive component of said one of the first and second oscillators;
said resistive component is implemented by a switched capacitive element; and
a control frequency of the switched capacitive element is determined by the frequency of the other one of the first and second oscillators.

2. Sensor according to claim 1, wherein said one of the first and second oscillators comprises:
an oscillating circuit; and
a current source configured to deliver a bias current to the oscillating circuit, the current source being of the type proportional to absolute temperature or of the type complementary to absolute temperature.

3. Sensor according to claim 2, wherein:
the current source comprises the resistive component;
the resistive component is configured to convert a voltage into a first current; and
the current source is configured so that the bias current is a copy of the first current to within a multiplication factor.

4. Sensor according to claim 3, wherein the oscillating circuit is a ring oscillator.

5. Sensor according to claim 3, wherein the oscillating circuit is a relaxation oscillator comprising an RS flip-flop.

6. Sensor according to claim 2, wherein the oscillating circuit comprises the resistive component.

7. Sensor according to claim 2, wherein:
said oscillating circuit comprises at least one first inverter having its threshold voltage determining the frequency of said one of the first and second oscillators; and
said one of the first and second oscillators further comprises:
a second inverter identical to the first oscillator and having its output connected to its input,
an error amplifier configured to deliver a signal indicating a deviation between an output voltage of the second inverter and a reference threshold voltage, and
a circuit configured to control a threshold voltage of the first and second inverters based on the signal delivered by the error amplifier so that the threshold voltage of the first and second inverters is equal to the reference voltage.

8. Sensor according to claim 1, wherein the sensor comprises a calibration circuit configured to:
receive from the counter the number P of periods of the second oscillator counted over the duration determined by the period of the first oscillator;
determine, when the calibration circuit receives a calibration request, and based on a known calibration temperature and on number P, a constant coefficient J such that:
a) P is equal to J times the calibration temperature if said one of the first and second oscillators is the first oscillator and has its frequency linearly depending on the inverse of temperature or if said one of the first and second oscillators is the second oscillator and has its frequency linearly depending on temperature; or
b) P is equal to J times the inverse of temperature if said one of the first and second oscillators is the second oscillator and has its frequency linearly depending on the inverse of temperature or if said one of the first and second oscillators is the first oscillator and has its frequency linearly depending on temperature.

9. Sensor according to claim 1, wherein the sensor comprises a calculation circuit configured to determine a temperature value based on said counted number.

10. Sensor according to claim 1, wherein the sensor is configured so that the duration determined by the frequency of the first oscillator is at least 100 times greater than a period of the second oscillator.

11. Sensor according to claim 1, wherein the sensor is configured so that the control frequency of the switched capacitive element is at least 10 times greater than the frequency of said one of the first and second oscillators.

12. Sensor according to claim 1, wherein each of the first and second oscillators comprises no quartz.
